(19) United States
(12) Patent Application Publication
(10) Pub. No.: US 2018/0238252 A1
(43) Pub. Date: Aug. 23, 2018

(54) Method for Backlash Reduction

(71) Applicant: GM Global Technology Operations LLC, Detroit, MI (US)

(72) Inventors: Christian Nichelmann, Hassenroth (DE); Stefan Horst, Neu-Isenburg (DE); Raik Schlemmer, Hohendubrau (DE)

(21) Appl. No.: 15/438,073

(22) Filed: Feb. 21, 2017

(51) Int. Cl. F02D 41/02; F02D 41/00; F02D 41/26

(52) U.S. Cl. CPC F02D 41/0215; F02D 41/0097; F02D 41/26; F02D 2250/18; F02D 2200/501; F02D 2200/602; F02D 2200/101

(57) ABSTRACT

A method for controlling a powertrain includes sensing a change in an accelerator pedal position indicative of a driver intended torque request, monitoring the actual engine torque and a change in driver intended torque request to determine if a trigger condition has been met, sensing an engine speed, calculating a virtual engine speed, calculating a difference between the engine speed and the virtual engine speed, determining if the difference in engine speed and virtual engine speed has exceeded a speed difference threshold, iteratively adjusting a torque output of the engine from a first value that is indicative of the driver intended torque request to a second value if the difference in engine speed and virtual engine speed has exceeded the speed difference threshold, comparing adjusted engine torque to expected torque, and applying a correction to an open loop torque control if adjusted torque differs too much from expected torque.

### INTRODUCTION

The statements in this section merely provide background information related to the present disclosure and may or may not constitute prior art. The present disclosure relates to systems and methods for managing lash in a vehicle powertrain, and more particularly, to control methods for controlling engine torque to manage lash in the powertrain.

Driveline lash or gear lash occurs when torque being transmitted through a transmission or a portion of a transmission reverses. Lash is a result of manufacturing tolerances and wear upon the components of the powertrain. Lash causes perceptible negative impacts to vehicle driving performance resulting in issues including clunks, audible noise and/or a perceptible jerk. Lash occurs on powertrains utilizing a single torque generative device such as an internal combustion engine or a motor generator. However, as a plurality of torque generative devices are utilized, for example, in a hybrid drive powertrain, management of lash is an increasing concern caused by transitions between the torque generative devices and the addition of interactions within the transmission to support the torque generative devices. Actions wherein driveline torque is transitioned from a positive torque to a negative torque, or from a neutral torque to a positive or negative torque can result in gear lash as slack is taken out of the driveline and driveline components impact one another. In certain driveline systems, abrupt torque reversals create high driveline impact forces. These impact forces result in tactile and audible noises, vibration and harshness that may result in operator discomfort and dissatisfaction, and can negatively affect powertrain and transmission reliability and durability.

While existing systems for mitigating driveline lash or gear lash are effective, there is a need in the art for improved driveline lash or gear lash reduction systems that improve the smoothness of the transitions between positive torque and negative torque, and from neutral torque to positive or negative torque. Especially desirable would be a system that manages torque generative devices in the driveline to make the positive/neutral/negative torque transitions less perceptible to operators while improving powertrain and transmission reliability and durability.

### SUMMARY

According to several aspects of the present disclosure a method for controlling a powertrain includes sensing a change in an accelerator pedal position indicative of a driver intended torque request. The method further includes sensing an actual engine torque, sensing an engine speed, sensing a vehicle speed, calculating a virtual engine speed from the vehicle speed, calculating a difference between the engine speed and the virtual engine speed, and calculating a speed difference threshold based on the driver intended torque request, actual engine torque, and the difference between the engine speed and the virtual engine speed.

In another aspect of the present disclosure, a method for controlling a powertrain includes monitoring the engine speed versus the virtual engine speed, determining a lash zone, and continuously monitoring the actual engine torque and the change in the accelerator pedal position to determine if a trigger condition has been met.

In yet another aspect of the present disclosure, the trigger condition includes a change in the accelerator pedal position indicative of a driver intended torque request and a difference between the actual engine torque and the driver intended engine torque request indicative of crossing the lash zone.

In yet another aspect of the present disclosure, the driver intended engine torque request indicative of crossing the lash zone includes the actual engine torque being below the lash zone and the driver intended engine torque request being above the lash zone, or the actual engine torque being above the lash zone and the driver intended engine torque request being below the lash zone.

In yet another aspect of the present disclosure, the driver intended engine torque request indicative of crossing the lash zone includes a tip-in throttle request involving a transition from a coasting condition or an engine decelerating condition to a positive throttle application, or a transition from a positive throttle application or accelerating condition to a coasting or an engine decelerating condition.

In yet another aspect of the present disclosure, a method for controlling a powertrain includes continuously monitoring the engine speed and the virtual engine speed to continuously calculate the difference between the engine speed and virtual engine speed.

In yet another aspect of the present disclosure, a method for controlling a powertrain includes sensing a driver intended torque request. The method further includes sensing an actual engine torque, sensing an engine speed, sensing a vehicle speed, calculating a virtual engine speed from the vehicle speed, and calculating a difference between the engine speed and the virtual engine speed. The method further includes calculating a speed difference threshold based on the driver intended torque request, actual engine torque, and the difference between the engine speed and the virtual engine speed. The method further includes determining a lash zone determining if the difference in engine speed and virtual engine speed has exceeded a speed difference threshold, and selectively and iteratively adjusting a torque output of an engine from a first value that is indicative of the driver intended torque request to a second value, if the difference in engine speed and virtual engine speed has exceeded the speed difference threshold and causes or is predicted to cause the powertrain to cross the lash zone.

In yet another aspect of the present disclosure the sensing a driver intended torque request further includes continuously monitoring an accelerator pedal position, and continuously monitoring a throttle actuator position.

In yet another aspect of the present disclosure, a method for controlling a powertrain includes continuously monitoring the actual engine torque and a change in an accelerator pedal position to determine if a trigger condition has been met. The trigger condition includes a change in the accelerator pedal position indicative of a driver intended torque request, and a difference between the actual engine torque and the driver intended engine torque request indicative of crossing the lash zone.

In yet another aspect of the present disclosure, a method for controlling a powertrain includes continuously monitoring the engine speed and the virtual engine speed to determine the difference between the engine speed and virtual engine speed.

In yet another aspect of the present disclosure the selectively and iteratively adjusting a torque output of the engine from a first value to a second value further includes modulating a torque output of the powertrain.

In yet another aspect of the present disclosure, a method for controlling a powertrain includes setting the torque output of the engine to the driver intended torque when the difference between the engine speed and virtual engine speed is below the speed difference threshold.

In yet another aspect of the present disclosure the selectively and iteratively adjusting a torque output of the engine further includes selectively and iteratively reducing torque when the driver intended torque request is indicated by an increase in the accelerator pedal position and selectively and iteratively increasing torque when the driver intended torque request is indicated by a decrease in the accelerator pedal position.

In yet another aspect of the present disclosure the selectively and iteratively adjusting a torque output of the engine further includes selectively and iteratively reducing torque when the driver intended torque request is indicated by an increase in the throttle actuator position and selectively and iteratively increasing torque when the driver intended torque request is indicated by a decrease in the throttle actuator position.

In yet another aspect of the present disclosure, a method for controlling a powertrain includes sensing a driver intended torque request. The method further includes sensing an actual engine torque, sensing an engine speed, sensing a vehicle speed, calculating a virtual engine speed from the vehicle speed, and calculating a speed difference threshold based on the driver intended torque request, the actual engine torque, and a difference between the engine speed and the virtual engine speed. The method further includes determining a lash zone, and determining if the difference in engine speed and virtual engine speed has exceeded a speed difference threshold. The method further includes selectively and iteratively adjusting a torque output of the engine from a first value that is indicative of the driver intended torque request to a second value if the difference in engine speed and virtual engine speed has exceeded the speed difference threshold and causes or is predicted to cause the powertrain to cross the lash zone. The method further includes comparing an actual torque management value to an expected torque management value, and applying a correction factor to an open loop torque management value.

In yet another aspect of the present disclosure, a method for controlling a powertrain includes continuously monitoring the actual engine torque and a change in the accelerator pedal position to determine if a trigger condition has been met. The trigger condition includes a change in the accelerator pedal position indicative of a driver intended torque request, and a difference between the actual engine torque and the driver intended engine torque request indicative of crossing the lash zone.

In yet another aspect of the present disclosure, determining the difference between the engine speed and the virtual engine speed further includes determining if the difference is greater than a threshold value.

In yet another aspect of the present disclosure, applying a torque management value further includes determining an expected torque management value from a predetermined plurality of expected torque management values. Each of the predetermined plurality of expected torque management values has a direct dependency with a predetermined plurality of actual torque values, and each of the predetermined plurality of actual torque values has a direct dependency with a predetermined plurality of driver requested torque values.

In yet another aspect of the present disclosure, comparing the actual torque management value to the expected torque management value further includes determining if the actual torque management value is substantially equivalent to the expected torque management value.

In yet another aspect of the present disclosure, a method for controlling a powertrain includes applying a correction factor to the open loop torque management value further includes adding an offset value to the open loop torque management value, or multiplying the open loop torque management value by an amount corresponding to a difference between the actual torque management value and the expected torque management value.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way. The components in the figures are not necessarily to scale, emphasis instead being placed upon illustrating the principles of the invention. Moreover, in the figures, like reference numerals designate corresponding parts throughout the views. In the drawings:

FIG. 1 is a schematic diagram of a powertrain system on which a method for backlash reduction operates according to an exemplary embodiment;

FIG. 2 is a functional block diagram of a control logic for the method for backlash reduction according to an exemplary embodiment;

FIG. 3 is a flowchart illustrating both an open and closed loop control logic method for backlash reduction according to an exemplary embodiment;

FIG. 4A is a graph of an accelerator pedal signal according to an exemplary embodiment;

FIG. 4B is a graph of a trigger signal according to an exemplary embodiment;

FIG. 4C is a graph of engine torque signals according to an exemplary embodiment;

FIG. 4D is a graph of engine speed signals according to an exemplary embodiment; and

FIG. 4E is a graph of vehicle acceleration signals according to an exemplary embodiment.

### DETAILED DESCRIPTION

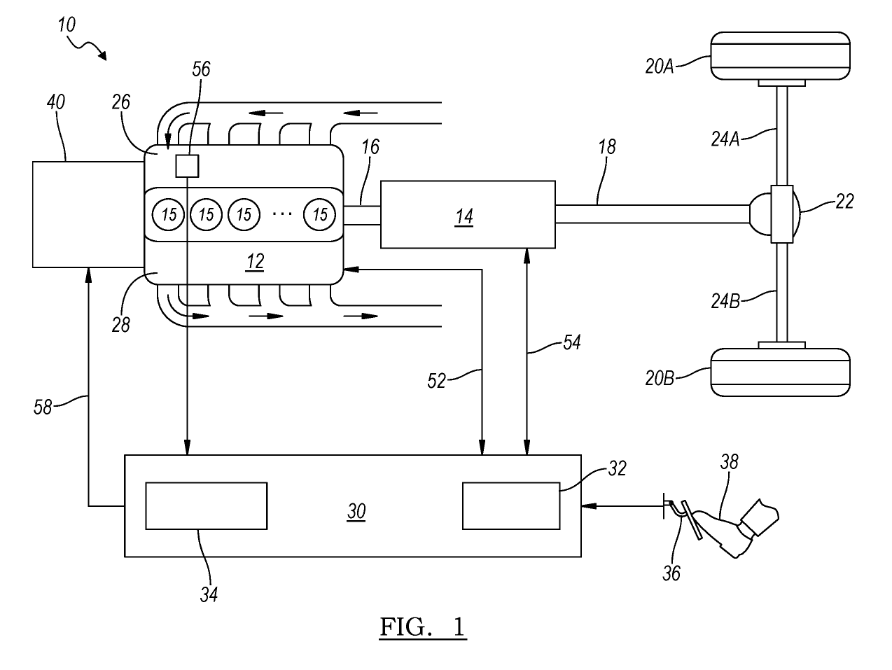

FIG. 1 illustrates a powertrain system 10 that makes use of a method for reducing backlash according to the principles of the following disclosure. The powertrain system 10 includes an internal combustion engine 12 and a transmission 14. The engine 12 is of the reciprocating piston type having one or more reciprocating pistons 15 journaled to a crankshaft 16. The crankshaft 16 is rotatably coupled to a transmission 14 input. A transmission 14 output is coupled to a pair of drive wheels 20a, 20b through a drive shaft 18, a differential gearset 22 and a set of half-shafts 24a, 24b. In another embodiment, the differential gearset 22 is part of the transmission 14. In one embodiment, the powertrain system 10 provides power to a front wheel drive vehicle with the engine 12 and transmission 14 configured transversely.

In another embodiment, not shown in FIG. 1, the engine 12 engages drive wheels 20a, 20b through a gearbox, clutch, torque converter, or other mechanical linkage as known in the art. Alternatively, the powertrain system 10 may include a torque converter positioned between engine 12 and transmission 14. The torque converter may be coupled to the engine 12 via the crankshaft 16 and may be coupled to the transmission 14 via a turbine shaft. The torque converter may include a clutch capable of being engaged. Torque converter input and output speeds may be used to determine a condition of transmission 14. In yet other embodiments, the transmission 14 may include an electronically controlled transmission with several gear ratios and various other gears that are selectable.

In one aspect, the engine 12 is of the four stroke diesel-fueled type with compression ignition and fuel injection. In other embodiments, the engine 12 can be of a spark-ignited type, the four-stroke type, the two-stroke type, and/or may not utilize any form of fuel injection. Furthermore, other embodiments may be differently fueled, such as by gasoline, ethanol, hydrogen, natural gas, propane, other gaseous or liquid fuels, and/or a hybrid combination of fuel types. In addition, powertrain system 10 may be used in hybrid applications that include one or more power sources in addition to the engine 12, such as batteries, fuel cells, electric motors and the like, as well as in applications with purely electrically-motivated powertrains.

Referring again to FIG. 1, the engine 12 includes an exhaust manifold 28 and an intake manifold 26 with a manifold air pressure sensor 56. In response to input from an operator 38 through the accelerator pedal position 36, fuel is supplied to the engine 12 by a fuel control mechanism 40. The fuel control mechanism 40 is regulated by a controller 30 via line 58. The controller 30 is operatively connected to fuel control mechanism 40 to modulate engine fueling and regulate related processes. The controller 30 utilizes pre-defined algorithms and look up tables based on various inputs and in response to certain engine operating conditions to determine a control mode for fuel control mechanism 40.

The controller 30 is included in a standard type of Engine Control Module (ECM), including one or more types of memory 32. The controller 30 can be an electronic circuit having of one or more components, including digital circuitry, analog circuitry, or both. The controller 30 may be a software and/or firmware programmable type; a hardwired, dedicated state machine or a combination of these.

In an embodiment, the controller 30 is a programmable microcontroller solid-state integrated circuit that integrally includes one or more processing units 34 and memory 32. The memory 32 can be composed of one or more components and can be of any volatile or nonvolatile type, including the solid state variety, the optical media variety, the magnetic variety, a combination of these, or such different arrangements as would occur to those skilled in the art. Further, while only one processing unit 34 is specifically shown in FIG. 1, more than one such unit can be included. When multiple processing units 34 are present, the controller 30 can be arranged to distribute processing among such units, and/or to provide for parallel or pipelined processing if desired. Operating logic defined by programming, hardware, or a combination of these dictates the operating parameters of the controller 30.

For example, the memory 32 stores programming instructions executed by processing unit 34 of the controller 30 to embody at least a portion of the operating logic. Alternatively, memory 32 stores data that is manipulated by the operating logic of the controller 30. The controller 30 can include signal conditioners, signal format converters (such as analog-to-digital and digital-to-analog converters), limiters, clamps, filters, and the like as needed to perform various control and regulation operations described in the present application. The controller 30 receives various inputs and generates various outputs to perform various operations as described hereinafter in accordance with its operating logic.

Referring once more to FIG. 1, the controller 30 is connected to and communicates with various devices of the engine 12 through a set of engine control signal pathways 52. Additionally, the controller 30 communicates with the transmission 14 via line 54. The controller 30 may also control shifting of the transmission 14. In the alternative, a separate controller 30 may exist for controlling transmission shifting or the transmission 14 may be of manual type without a controller 30. In a further variation in which the transmission 14 is operator-controlled or a manual transmission shifting system, there may be communication between the controller 30 and components of the transmission 14 via line 54 in the direction to transmit a status of the transmission 14 to the controller 30. Controller connections may be implemented with a dedicated, direct line through an electrical or optical cable, a wireless communication connection, and/or through any compatible bus, network, communication interface, or the like. In one example, a CAN (Controller Area Network) bus is utilized.

As will be explained below, controller 30 operates in response to a number of inputs, including, but not limited to, engine speed, accelerator pedal position 36, driver torque request, engine control state, clutch switch input, out-of-gear status, virtual engine speed (not shown), transmission 14 type, and/or torque converter duty cycle.

Torque produced by the engine 12 can change rapidly in response to certain operator inputs such as acceleration (Tip-In) and deceleration (Tip-Out). Rapid changes in torque occurring with an abrupt torque reversal result in high driveline impact forces. These impact forces, which are amplified in drivelines containing high levels of included lash, result in tactile and audible noise, vibration, and harshness. All vehicle drivelines contain lash, since it is inherent in the use of gear meshes, splines, slip yokes, dampers etc. In one aspect the present disclosure includes a technique for minimizing driveline impact reverberation by controlling torque changes during both Tip-In and Tip-Out events without the use of additional mechanical or electrical components.

In an embodiment, the controller 30 receives input from the engine 12, via the engine control signal pathway 52, including engine operating parameters. The controller 30 operates to determine a detected engine torque as a function of inputs of the operating parameters of the engine 12. A detected engine torque could represent the current operating parameters of engine 12. In another embodiment, the controller 30 operates to detect operating parameters of the transmission 14 as a function of the inputs from the transmission 14 via line 54. Transmission inputs may include gear selection, gear selection position, clutch switch status, clutch engagement status and out-of-gear status. The controller 30 may be preprogrammed with data such as transmission type and related gear mechanism configurations. The preprogrammed data and the transmission inputs may be factors in determinations made by controller 30 regarding a transmission status such as whether the driveline is engaged or disengaged. In at least some operator-controlled or manual transmission embodiments, the controller 30 may not communicate with the transmission 14. In still other embodiments, the transmission 14 may be controlled by a device separate and independent of the controller 30.

In one aspect, the controller 30 receives a requested engine torque from the operator 38. The operator 38 transfers a selection of torque requirements to engine 12 by providing the controller 30 with input from accelerator pedal position 36. The operator 38 is capable of signaling an acceleration request or Tip-In event, and the operator 38 is also capable of signaling a deceleration or Tip-Out event.

Upon completion of receiving and processing inputs for determining a requested engine torque, the controller 30 detects a set of engine operating parameter conditionals such as transmission 14 status, gear status, engine speed and/or virtual engine speed. If the engine operating parameter conditionals are met, the controller 30 determines a torque value from detected engine torque and requested engine torque. If the torque value is determined to be within a range of torque change which creates high driveline impact forces, the controller 30 can provide a torque change control output. In one aspect, the torque change control output may represent a fueling rate sent to fuel control mechanism 40 via line 58 which modifies the torque transition as the torque moves through torque reversal. When the torque change control output is implemented, the duration of time during which the torque reversal occurs increases. Therefore, the modified torque transition is implemented over a period of time commensurate with the increased duration of the torque reversal so that the torque change control output continues to adjust as the duration of time of the torque reversal increases. The torque transition can be calculated from the change in torque over the change in time.

To keep the modified torque transition from being perceived by operator 38 as a sluggish performance during acceleration or Tip-In situations or a noticeable lack of deceleration or run-on for Tip-Out situations, multiple torque transitions can be applied to engine 12 as the torque moves through torque thresholds. In one embodiment through the application of engine fueling, spark timing, and torque management software algorithms, engine fueling, spark timing, and torque is controlled to extend the time over which a driveline torque reversal occurs while also limiting torque transmitted during the driveline torque reversal. During a change in torque, engine fueling, spark timing, and torque controls use multiple software definable threshold values to accomplish different fueling rates and spark timing events. By incorporating engine fueling, spark timing, and torque data with throttle position information in the operations of the controller 30, engine fueling, spark timing, and torque are controlled during driveline torque reversals while having no discernible impact on engine operation or performance.

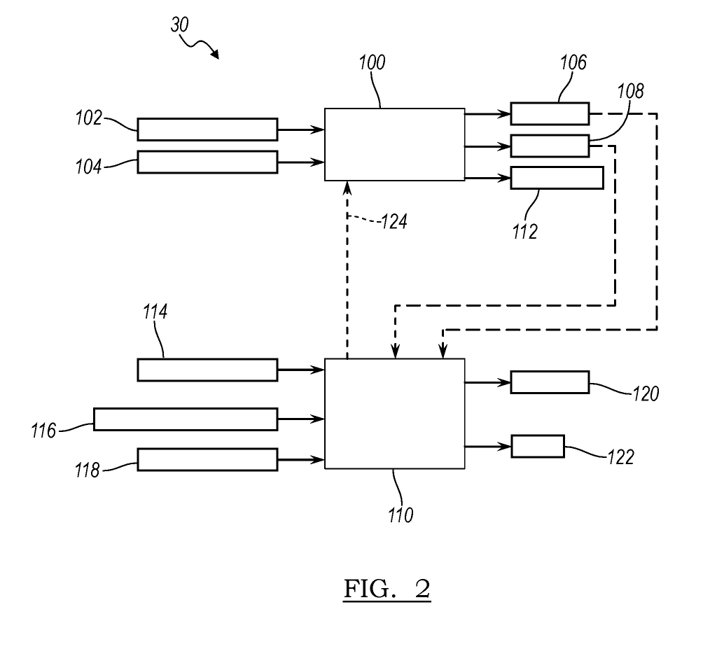

Referring now to FIG. 2, a functional block diagram of the control logic is illustrated. The controller 30 includes both open loop 100 and closed loop 110 control logic. The open loop control 100 receives an operator request 102 and a response target 104. The operator request 102 is a request for torque. In one example, the operator request 102 is a request generated by the operator 38 via an accelerator pedal position 36. In another example, the operator request 102 is a torque request generated by the operator 38 or by the controller 30 during operation of a cruise control algorithm. The operator request 102 corresponds to the response target 104 in a first lookup table. From the operator request 102 and response target 104, a first torque output 106, engine speed output 108, and initial response 112 are generated. The initial response 112 is a value calculated from vehicle speed and transmission 14 gear ratios, and is drawn from the values in the first lookup table. When a difference between the first torque output 106 and/or the engine speed output 108 and the virtual engine speed (not shown) is detected, the signals indicative of the first torque output 106, engine speed output 108, and virtual engine speed are fed into the closed loop control 110. The closed loop control 110 continuously receives inputs including actual system conditions 114, actual environmental conditions 116 and comfort targets 118. The closed loop control 110 iteratively generates a second torque output 120 based on a second lookup table having second torque output 120 values corresponding to the relative size of the difference between the engine speed output 108 and the virtual engine speed. The second torque output 120 produces a certain level of lash or kick 122. As the difference between the engine speed output 108 and the virtual engine speed approaches a predetermined value, a signal indicative of an adjusted torque value 124 is fed back into the open loop control 100. The adjusted torque value 124 modifies the first torque output 106 generated by the open loop control 100.

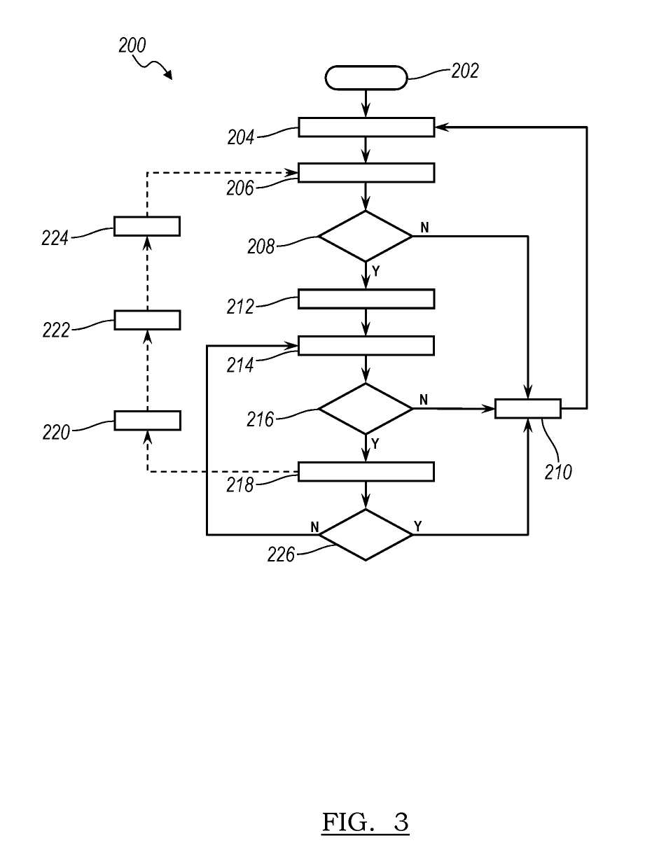

Referring now to FIG. 3, and with continuing reference to FIGS. 1 and 2, a flowchart illustrating both an open loop and a closed loop control method is shown. At block 202, the control method 200 is initiated. At block, 204, control method 200 monitors the accelerator pedal position 36. At block 206, the control method 200 applies open loop control 100 to manage engine 12 torque output. At block 208, the method 200 determines whether a change in engine 12 load is possible, and whether the change in engine 12 load may result in a disparity between the vehicle speed and the engine speed. In other words, the method 200 determines whether an engine 12 load change is present that may cause a kick 122. If no engine 12 load change is present that may cause a kick 122, the method proceeds to block 210 and the engine 12 torque output is set to the operator 38 intended torque output. In one aspect, when no change is detected, the powertrain system 10 is fully-engaged and/or fully disengaged, and lash in the powertrain system 10 has been taken up. From block 210, the control method 200 returns to block 204 where the control method 200 once again monitors the accelerator pedal position 36. However, if an engine 12 load change is present that is capable of causing a kick 122, the method 200 proceeds to block 212 where the method 200 monitors the vehicle speed. At block 214, the control method 200 calculates a difference between the engine speed output 108 and the virtual engine speed (not shown). In one aspect, a difference between the engine speed output 108 and the virtual engine speed exists when the powertrain system 10 is undergoing a torque reversal. At block 216, the control method 200 determines if the difference between the engine speed output 108 and virtual engine speed has exceeded a threshold value. If the difference between the engine speed output 108 and the virtual engine speed has not exceed the threshold value, the method proceeds to block 210, and the torque produced by the engine 12 is set to be substantially equal to the torque requested by the operator 38. From block 210, the control method 200 returns to block 204 where the control method 200 once again monitors the accelerator pedal position 36. However, if the difference between the engine speed output 108 and the virtual engine speed has exceeded the threshold value, the method proceeds to block 218.

At block 218, because the difference between the engine speed output 108 and the virtual engine speed has exceeded the threshold value, the method 200 performs two distinct functions. In the first function, at block 218, torque management values from the second lookup table are applied in closed loop control 110. In the second function, the method 200 sends information about the torque management values to the open loop control 100 via a series of steps in blocks 220-224. At block 220 the amplitude of the torque management values that have been applied is checked. At block 222, the amplitude of the torque management values are compared to the amplitude of the expected torque management values in a lookup table populated with predetermined torque management values. At block 224, any disparity between the torque management values and the expected torque management values is used to create a correction factor that is applied to the open loop control 100. In one aspect, the predetermined torque management values in the lookup table are experimentally determined and directly proportional to the difference between the engine speed output 108 and the virtual engine speed.

In a first example, the operator 38 makes a request 102 of the powertrain system 10 that causes the powertrain system 10 to engage in a torque reversal from a coasting condition to an accelerating condition, and lash ora kick 122 in the powertrain system 10 is possible. In other words, in the first example, a difference between engine 12 actual torque output and initial response torque output can occur. To adjust for the difference between engine 12 torque output and initial response torque output and to mitigate resultant powertrain system 10 lash or kick 122, the control method 200 alters the manner in which torque is delivered to the powertrain system 10. In one aspect the control method 200 decreases some torque with closed loop control 110 of engine 12 torque. In another aspect, the control method 200 alters the rate at which engine 12 torque is requested of the powertrain system 10.

In a second example, the operator 38 makes a request 102 of the powertrain system 10 that causes the powertrain system 10 to engage in a torque reversal from an accelerating condition to a coasting condition, and lash or a kick 122 in the powertrain system 10 is possible. In other words, in the second the request 102 generates an initial response torque output value that is temporarily greater than the operator-intended torque value. In the second example, the torque management values temporarily operate to reduce the amount of torque generated by the engine 12. In the second example, a difference between engine 12 actual torque output and initial response torque output occurs. To adjust for the difference between engine 12 torque output and initial response torque output and to mitigate resultant powertrain system 10 lash or kick 122, the control method 200 alters the manner in which torque is delivered to the powertrain system 10. In one aspect the control method 200 increases some torque with closed loop control 110 of engine 12 torque. In another aspect, the control method 200 alters the rate at which engine 12 torque is requested of the powertrain system 10. In both the first and second examples, the closed loop control 110 of engine 12 torque to mitigate lash or kick 122 can be accomplished by altering engine 12 spark efficiency, altering fuel injection amounts, altering an angle of a throttle valve or the like without departing from the scope or intent of the present disclosure.

In one aspect, by adjusting the open loop control 100, and more particularly, by adjusting the open loop control 100 first lookup table, the closed loop control 110 adjusts for powertrain system 10 lash caused by aging effects, etc. Additionally, at block 224, once the control method 200 adjusts the open loop control 100, the method returns to block 206 and once again applies open loop control 100 until at block 208 the method 200 determines that a load change is occurring which may produce a difference between engine speed output 108 and virtual engine speed.

From block 218, the control method 200 proceeds to block 226 where the control method 200 determines if tolerances within the drivetrain have been gained. That is, at block 226, the control method 200 determines if the torque management values were sufficient to substantially mitigate driveline lash or kick 122. If the tolerances within the drivetrain have been gained, the control method 200 proceeds to block 210 and the torque produced by the engine 12 is substantially equal to the torque requested by the operator 38. From block 210, the control method 200 returns to block 204 where the control method 200 once again monitors the accelerator pedal position 36. However, if the tolerances within the drivetrain have not been gained, the control method 200 proceeds back to block 214, and the control method 200 calculates the difference between the engine speed output 108 and the virtual engine speed.

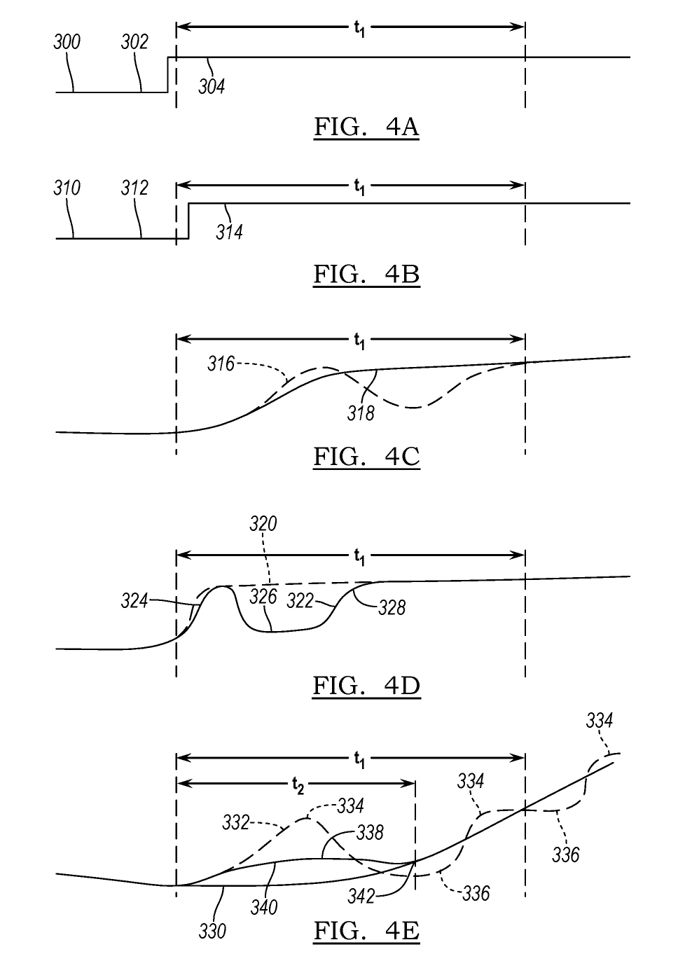

Turning now to FIGS. 4A-E, and with continuing reference to FIGS. 1-3, a series of graphs indicative of vehicle operation during a period of time in which the vehicle is transitioning from a coasting condition to an accelerating condition are illustrated, in accordance with the present invention. FIG. 4A is a graph of a signal 300 that is indicative of a pedal change. When a pedal change occurs the pedal change signal 300 transitions from a low value 302 to a high value 304. In one example, the low value 302 represents a accelerator pedal position 36 corresponding to a coasting condition, and the high value 304 represents a accelerator pedal position 36 corresponding to an accelerating condition.

FIG. 4B is a graph of a trigger signal 310 that transitions from a low level 312 to a high level 314 when a accelerator pedal position 36 change is detected, and when a torque reversal is predicted. When trigger signal 310 transitions from the low level 312 to the high level 314, the control method 200 described above is initiated, and torque management values are applied to the powertrain system 10 to reduce operator 38 discomfort, improve response and reduce wear on the powertrain system 10. However, it should be understood that when a accelerator pedal position 36 change is detected, but no torque reversal is predicted, the trigger signal 310 would remain at the low level 312. That is, when a accelerator pedal position 36 change occurs, but the vehicle is accelerating from a partial throttle condition to a higher partial throttle condition, no torque reversal is expected, and the method 200 will not be initiated. Similarly, when the accelerator pedal position 36 change is from a decelerating partial throttle condition to a lower partial throttle condition, or a coasting condition, no torque reversal is expected, no torque reversal is expected, and the method 200 will not be initiated.

FIG. 4C is a graph of vehicle engine torque signals corresponding to the accelerator pedal position 36 signal of FIG. 4A and the trigger signal of FIG. 4B. Dashed line torque trace 316 represents vehicle torque signal for a motor vehicle having no control method for reducing backlash in the powertrain system 10. In the example of the dashed line torque trace 316, in response to the accelerator pedal position 36 change, the powertrain system 10 experiences a torque reversal from a coasting condition to an accelerating condition. During the torque reversal lash take-up, indicated by the time “t₁”, lash within the powertrain system 10 results in a temporary difference between the engine speed output 108 and the virtual engine speed. The temporary difference in engine speed output 108 versus the virtual engine speed results in clunks, jerks, and other related events may result in operator 38 discomfort and dissatisfaction, and can negatively affect powertrain and transmission 14 reliability and durability. The clunks, jerks, and other related events are graphically depicted by the wavy character of the dashed line torque trace 316.

By contrast, solid line torque trace 318 represents a vehicle torque signal for a motor vehicle utilizing the control method 200 of torque management according to the present disclosure. During the torque reversal lash take-up time “t₁”, the controller 30 applies torque management values according to the control method 200 of FIG. 3. The torque management values from the control method 200 create a substantially smooth character for the solid line torque trace 318. Therefore, the clunks, jerks, and other related events that would otherwise be present due to lash within the powertrain system 10 are substantially mitigated by the control method 200, as will be described in greater detail below.

FIG. 4D is a graph of vehicle engine torque signals corresponding to the accelerator pedal position 36 signal of FIG. 4A, the trigger signal of FIG. 4B, and the resulting vehicle acceleration of FIG. 4C. Dashed line torque trace 320 represents a vehicle torque signal for a motor vehicle undergoing a torque reversal. Furthermore, the dashed line torque trace 320 depicts a torque signal for a motor vehicle having no control method for reducing backlash in the powertrain system 10. In response to the operator 38 torque request as sensed by the change in accelerator pedal position 36, the controller 30 simply requests torque from the engine 12. In the powertrain system 10 in which no control method is applied, the torque request approximates a step function that largely corresponds to the pedal position signal 300 and trigger signal 310.

By contrast, solid line torque trace 322 represents a vehicle torque signal for a motor vehicle using the control method 200 for torque management for reducing backlash in the powertrain system 10, according to the principles of the present disclosure. During the torque reversal lash take-up time “t₁”, the control method 200 intercepts the operator 38 torque request and modifies the engine 12 torque output. That is, the control method 200 alters the torque request to mitigate the clunks, jerks, and other related events that would otherwise be present due to lash within the powertrain system 10. It should be appreciated that while the solid line torque trace 322 is depicted as having a particular shape with a first torque peak 324, a torque trough 326, and a second torque peak 328, the actual torque management values produced by the control method 200 vary depending on the type and severity of torque management required. For example, in a situation in which the operator 38 causes the motor vehicle powertrain system 10 to transition rapidly from a coasting condition to a wide-open-throttle (WOT) condition, the solid line torque trace 322 could include additional torque peaks and/or troughs, as well as an increased slope for each of the peaks and/or troughs.

FIG. 4E is a graph of vehicle engine speed signals corresponding to the throttle pedal position signal 300 of FIG. 4A, the trigger signal of FIG. 4B, the vehicle acceleration signal of FIG. 4C, and the torque signals of FIG. 4D. In FIG. 4E, solid line trace 330 depicts a virtual engine speed. The virtual engine speed 330 is an idealized engine speed as determined based on the application of torque to an idealized powertrain system 10 in which there is negligible lash.

Dashed line engine speed trace 332 represents an actual engine speed signal for a non-idealized powertrain system 10 having lash. The non-idealized powertrain system 10 relating to the engine speed trace 332 is undergoing a torque reversal. Furthermore, the dashed line engine speed trace 332 is depicted as it applies to a powertrain system 10 having no control method 200 for torque management for reducing backlash. In response to the operator 38 torque request as sensed by the change in accelerator pedal position 36, the controller 30 simply requests torque from the engine 12. By applying unmanaged torque according to the dashed line torque trace 320 of FIG. 4D, a series of clunks, jerks, and other related events are generated within the non-idealized powertrain system 10. The series of clunks, jerks, and other related events are depicted within the dashed line engine speed trace 332 as a series of peaks 334 and troughs 336.

By contrast, solid line trace 338 represents an actual engine speed signal for a powertrain system 10 using the control method 200 for torque management. During the torque reversal lash take-up time “t₁”, the control method 200 intercepts the operator 38 torque request and modifies the engine 12 torque output according to the solid line torque trace 322 of FIG. 4D. That is, the control method 200 alters the torque request to mitigate the clunks, jerks, and other related events that would otherwise be present due to lash within the powertrain system 10. It should be appreciated that while the solid line engine speed trace 338 is depicted as having a particular shape with an engine speed peak 340, and an engine speed trough 342, the actual engine speed trace 338 profile varies depending on the type and severity of torque management required. In the example in which the operator 38 causes the motor vehicle powertrain system 10 to transition rapidly from a coasting condition to a wide-open-throttle (WOT) condition, the solid line engine speed trace 338 could include additional engine speed peaks 340 and/or troughs 342 as well as an increased slope for each of the peaks 340 and/or troughs 342. However, it should be appreciated, that the relative severity, quantity, and amplitude of the engine speed peaks 340 and/or troughs 342 is substantially decreased relative the engine speed peaks 334 and/or troughs 336 in the dashed line engine speed trace 332 without the control method 200 applied. Moreover, it should be noted that in the example of the powertrain system 10 using the control method 200, a managed torque reversal lash take-up time “t₂” during which any engine speed peaks 334 and/or troughs 336 are present is substantially decreased from the during the torque reversal lash take-up time “t₁”. Furthermore, because the duration of time “t₂” is substantially less than the duration of time “t₁”, the duration of any clunks, jerks, and other related events is decreased, and operator 38 comfort and satisfaction is increased.

The method 200 for backlash reduction of the present disclosure offers several advantages. These include smoothing torque reversals in the powertrain system 10, reducing wear on system 10 components, as well as reducing discomfort for the operator 38 discomfort.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for controlling a powertrain, the method comprising:
sensing a change in an accelerator pedal position indicative of a driver intended torque request;
sensing an actual engine torque;
sensing an engine speed;
sensing a vehicle speed;
calculating a virtual engine speed from the vehicle speed;
calculating a difference between the engine speed and the virtual engine speed;
calculating a speed difference threshold based on the driver intended torque request, actual engine torque, and the difference between the engine speed and the virtual engine speed.

2. The method of claim 1 further comprising monitoring the engine speed versus the virtual engine speed; determining a lash zone, and continuously monitoring the actual engine torque and the change in the accelerator pedal position to determine if a trigger condition has been met.

3. The method of claim 2 wherein the trigger condition comprises a change in the accelerator pedal position indicative of a driver intended torque request and a difference between the actual engine torque and the driver intended engine torque request indicative of crossing the lash zone.

4. The method of claim 3 wherein the driver intended engine torque request indicative of crossing the lash zone comprises the actual engine torque being below the lash zone and the driver intended engine torque request being above the lash zone, or the actual engine torque being above the lash zone and the driver intended engine torque request being below the lash zone.

5. The method of claim 4 wherein the driver intended engine torque request indicative of crossing the lash zone comprises a tip-in throttle request involving a transition from a coasting condition or an engine decelerating condition to a positive throttle application, or a transition from a positive throttle application or accelerating condition to a coasting or an engine decelerating condition.

6. The method of claim 5 further comprising continuously monitoring the engine speed and the virtual engine speed to continuously calculate the difference between the engine speed and virtual engine speed.

7. A method for controlling a powertrain, the method comprising:
sensing a driver intended torque request;
sensing an actual engine torque;
sensing an engine speed;
sensing a vehicle speed;
calculating a virtual engine speed from the vehicle speed;
calculating a difference between the engine speed and the virtual engine speed;
calculating a speed difference threshold based on the driver intended torque request, actual engine torque, and the difference between the engine speed and the virtual engine speed;
determining a lash zone;
determining if the difference in engine speed and virtual engine speed has exceeded a speed difference threshold; and
selectively and iteratively adjusting a torque output of an engine from a first value that is indicative of the driver intended torque request to a second value, if the difference in engine speed and virtual engine speed has exceeded the speed difference threshold and causes or is predicted to cause the powertrain to cross the lash zone.

8. The method of claim 7 wherein the sensing a driver intended torque request further comprises continuously monitoring an accelerator pedal position, and continuously monitoring a throttle actuator position.

9. The method of claim 8, further comprising continuously monitoring the actual engine torque and a change in an accelerator pedal position to determine if a trigger condition has been met, wherein the trigger condition comprises a change in the accelerator pedal position indicative of a driver intended torque request, and a difference between the actual engine torque and the driver intended engine torque request indicative of crossing the lash zone.

10. The method of claim 9, further comprising continuously monitoring the engine speed and the virtual engine speed to determine the difference between the engine speed and virtual engine speed.

11. The method of claim 10 wherein the selectively and iteratively adjusting a torque output of the engine from a first value to a second value further comprises modulating a torque output of the powertrain.

12. The method of claim 11, further comprising setting the torque output of the engine to the driver intended torque when the difference between the engine speed and virtual engine speed is below the speed difference threshold.

13. The method of claim 12 wherein the selectively and iteratively adjusting a torque output of the engine further comprises selectively and iteratively reducing torque when the driver intended torque request is indicated by an increase in the accelerator pedal position and selectively and iteratively increasing torque when the driver intended torque request is indicated by a decrease in the accelerator pedal position.

14. The method of claim 12 wherein the selectively and iteratively adjusting a torque output of the engine further comprises selectively and iteratively reducing torque when the driver intended torque request is indicated by an increase in the throttle actuator position and selectively and iteratively increasing torque when the driver intended torque request is indicated by a decrease in the throttle actuator position.

15. A method for controlling a powertrain, the method comprising:
sensing a driver intended torque request;
sensing an actual engine torque;
sensing an engine speed;
sensing a vehicle speed;
calculating a virtual engine speed from the vehicle speed;
calculating a speed difference threshold based on the driver intended torque request, the actual engine torque, and a difference between the engine speed and the virtual engine speed;
determining a lash zone;
determining if the difference in engine speed and virtual engine speed has exceeded a speed difference threshold;
selectively and iteratively adjusting a torque output of the engine from a first value that is indicative of the driver intended torque request to a second value if the difference in engine speed and virtual engine speed has exceeded the speed difference threshold and causes or is predicted to cause the powertrain to cross the lash zone;
comparing an actual torque management value to an expected torque management value; and
applying a correction factor to an open loop torque management value.

16. The method of claim 15, further comprising continuously monitoring the actual engine torque and a change in the accelerator pedal position to determine if a trigger condition has been met, wherein the trigger condition comprises a change in the accelerator pedal position indicative of a driver intended torque request, and a difference between the actual engine torque and the driver intended engine torque request indicative of crossing the lash zone.

17. The method of claim 16 wherein determining the difference between the engine speed and the virtual engine speed further comprises determining if the difference is greater than a threshold value.

18. The method of claim 17 wherein applying a torque management value further comprises determining an expected torque management value from a predetermined plurality of expected torque management values, wherein each of the predetermined plurality of expected torque management values has a direct dependency with a predetermined plurality of actual torque values, and wherein each of the predetermined plurality of actual torque values has a direct dependency with a predetermined plurality of driver requested torque values.

19. The method of claim 18 wherein comparing the actual torque management value to the expected torque management value further comprises determining if the actual torque management value is substantially equivalent to the expected torque management value.

20. The method of claim 19 wherein applying a correction factor to the open loop torque management value further comprises adding an offset value to the open loop torque management value, or multiplying the open loop torque management value by an amount corresponding to a difference between the actual torque management value and the expected torque management value.
